(19) United States
(12) Patent Application Publication
(10) Pub. No.: US 2008/0158644 A1
(43) Pub. Date: Jul. 3, 2008

(54) POLARIZATION SCRAMBLER APPARATUS, TRANSMISSION APPARATUS, REPEATING INSTALLATION AND POLARIZATION SCRAMBLER METHOD

(75) Inventors: Akihiko ISOMURA, Kawasaki (JP); Jens Rasmussen, Kawasaki (JP); Kazuo Hironishi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 11/963,194

(22) Filed: Dec. 21, 2007

(30) Foreign Application Priority Data
Dec. 28, 2006 (JP) 2006-355477

(51) Int. Cl. G02F 1/09; G02B 27/28

(52) U.S. Cl. 359/282; 359/485

(57) ABSTRACT

An apparatus and method scrambling a polarization state of signal light using at least three Faraday rotators and at least two wave plates. The apparatus also scrambles input signal light and outputs the signal light by a capacitor connected in series or in parallel with a Faraday rotator and being driven in resonance with the Faraday rotator.

### CROSS-REFERENCE TO RELATED APPLICATIONS

This application is related to and claims priority to Japanese patent application No. 2006-355477 filed on Dec. 28, 2006, in the Japan Patent Office, and incorporated by reference herein.

### BACKGROUND

1. Field of the Invention

The present invention relates to a polarization scrambler apparatus, a transmission apparatus, a repeating installation, and a polarization scrambler method for scrambling the polarization state of signal light in an optical transmission system.

2. Description of the Related Art

Conventionally, in optical transmission systems to enhance the polarization mode dispersion (PMD) tolerance technologies for combining forward error correction (FEC) and a polarization scrambler have been used. An example of one of the polarization scramblers used is a Faraday rotator which is a magneto-optic element for rotating the polarization state of signal light.

For example, when improving the PMD tolerance of the signal light modulated by differential quadrature phase shift keying (DQPSK) at 40 Gbps, a response speed of not less than 1 MHz is required of a polarization scrambler to apply FEC.

### SUMMARY

An embodiment of the present invention provides an apparatus that includes polarizing parts disposed on an optical path of an input signal light and adapted to rotate a polarization state of the input signal light and to output the signal light and wave plates interposed between the polarizing parts and adapted to rotate the polarization state of the signal light output from the polarizing parts and to output the signal light.

According to the disclosed apparatus and method, it is possible to rotate the polarization state of signal light by a three polarization unit while changing the polarization state of the signal light by wave plates.

Another embodiment of the present invention provides an apparatus including a Faraday rotator for rotating a polarization state of an input signal light and outputting the signal light, and a capacitor connected in series or in parallel with a Faraday rotator and being driven in resonance with the Faraday rotator.

According to the disclosed apparatus and method, it is possible to apply a high voltage to a Faraday rotator using a low drive voltage, by producing resonance between the Faraday rotator and a capacitor.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of a configuration of a polarization scrambler apparatus;

FIG. 2 is a flow chart illustrating an example of a setting operation of a polarization scrambler apparatus;

FIG. 3A is a diagram illustrating an example of a change of polarization state of signal light caused by the polarization scrambler apparatus illustrated in FIG. 2;

FIG. 3B is a diagram illustrating another example of a the change of polarization state of signal light caused by the polarization scrambler apparatus illustrated in FIG. 2;

FIG. 3C is a diagram illustrating another change of polarization state of signal light caused by the polarization scrambler apparatus illustrated in FIG. 2;

FIG. 4 is a diagram illustrating another example of a configuration of the polarization scrambler apparatus;

FIG. 5 is a flow chart illustrating an example of the operation of the polarization scrambler apparatus illustrated in FIG. 4;

FIG. 6A is a diagram illustrating a change of a polarization state of signal light caused by the polarization scrambler apparatus illustrated in FIG. 4;

FIG. 6B is a diagram illustrating an example of change of polarization state of signal light caused by the polarization scrambler apparatus illustrated in FIG. 4;

FIG. 6C is a diagram illustrating a change of polarization state of signal light caused by the polarization scrambler apparatus illustrated in FIG. 4;

FIG. 7 is a diagram illustrating another example of a configuration of the polarization scrambler apparatus;

FIG. 8 is a functional block diagram illustrating a part of a configuration of a polarization scrambler apparatus;

FIG. 9A is a diagram illustrating an example of a waveform displayed by the oscilloscope illustrated shown in FIG. 8;

FIG. 9B is a diagram illustrating another example of a waveform displayed by the oscilloscope illustrated in FIG. 8;

FIG. 9C is a diagram illustrating another example of a waveform displayed by the oscilloscope illustrated in FIG. 4;

FIG. 10 is a functional block diagram illustrating an example of a configuration of an optical transmission system in which a polarization scrambler is applied to a transmitter;

FIG. 11 is a functional block diagram illustrating an example of a configuration of an optical transmission system in which a polarization scrambler is applied to a multiplexer;

FIG. 12 is a functional block diagram illustrating an example of a configuration of an optical transmission system in which a polarization scrambler apparatus is applied to a repeating installation;

FIG. 13 is a diagram illustrating a Poincare sphere which represents an example of a polarized state of signal light; and

FIG. 14 is a diagram illustrating a relationship between scrambling frequency and penalty on a receiving side of a polarization scrambler apparatus.

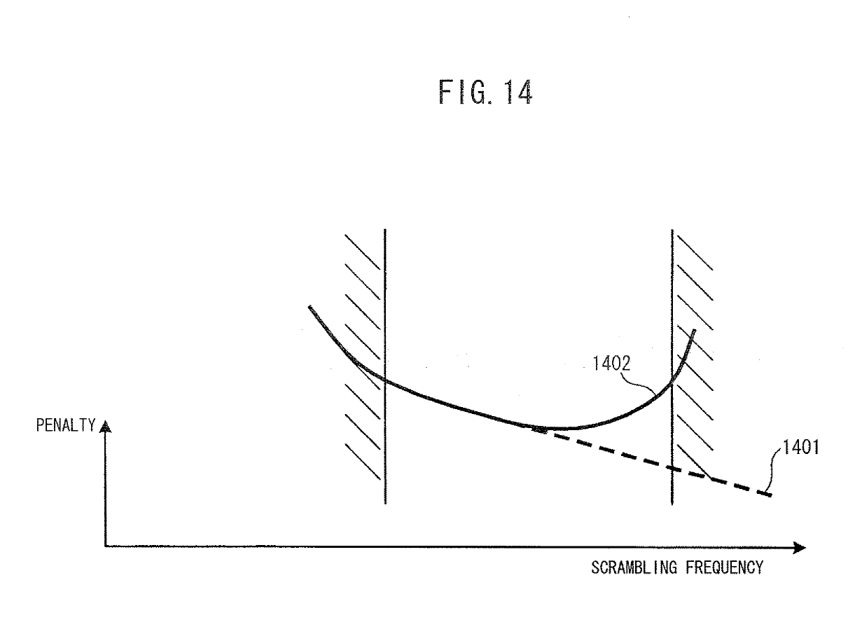

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

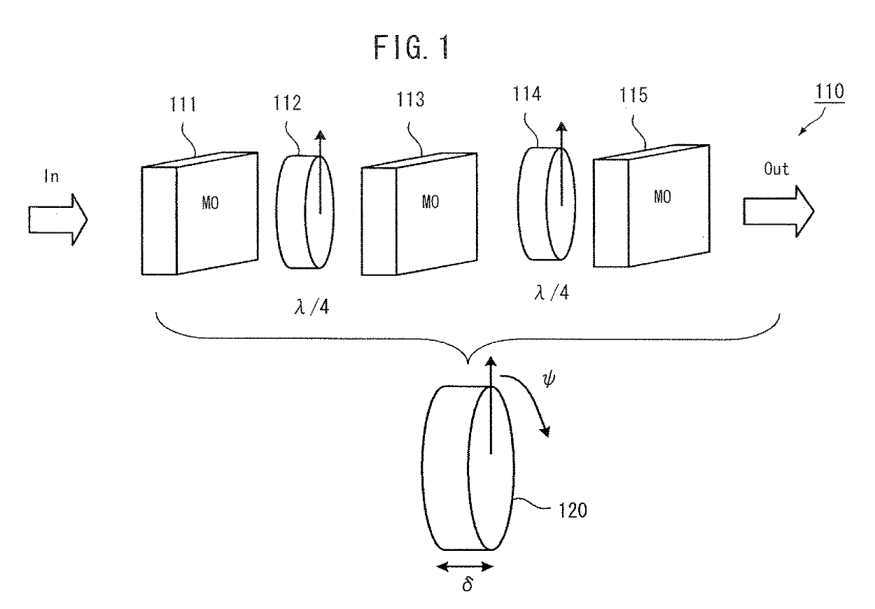

FIG. 1 illustrates an example of one embodiment of configuration of a polarization scrambler apparatus. As illustrated in FIG. 1, the polarization scrambler apparatus 110 includes a Faraday rotator (MO: Magneto-Optic) 111, a λ/4 wave plate 112, a Faraday rotator (MO) 113, a λ/4 wave plate 114, and a Faraday rotator (MO) 115.

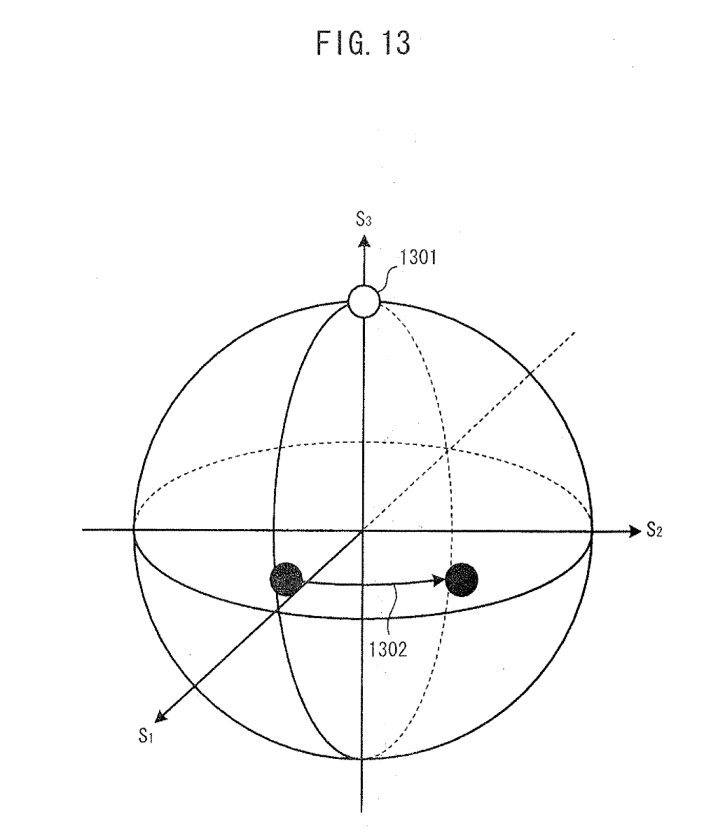

The Faraday rotator 111 rotates (scrambles) the polarization state of an input signal light. The Faraday rotator 111 outputs the signal light having a rotated polarization state to the λ/4 wave plate 112. The Faraday rotator 111 rotates the polarization state of the signal light with the S1 axis of the Poincare sphere illustrated in FIG. 13 as the rotational axis. Further, the Faraday rotator 111 rotates the polarization state of the signal light at a speed ψ.

The λ/4 wave plate 112 rotates the polarization state of the signal light to be output from the Faraday rotator 111 by 90 degrees or substantially 90 degrees (“about 90 degrees”), The λ/4 wave plate 112 outputs the signal light, in which the polarization state has been rotated by about 90 degrees to the Faraday rotator 113. The Faraday rotator 113 rotates the polarization state of the signal light to be output from the λ/4 wave plate 112. The Faraday rotator 113 outputs the signal light of which the polarization state has been rotated to the λ/4 wave plate 114.

The polarization state of the signal light to be output to the Faraday rotator 113 is rotated about 90 degrees compared with that of the signal light to be input to the Faraday rotator 111 as a result of passing through the λ/4 wave plate 112. That is, in this case, the Faraday rotator 113 rotates the polarization state of the signal light with the S2 axis of the Poincare sphere illustrated in FIG. 13 as the rotational axis.

The λ/4 wave plate 114 rotates the polarization state of the signal light to be output from the Faraday rotator 113 by about 90 degrees. The λ/4 wave plate 114 outputs the signal light of which the polarization state has been rotated by about 90 degrees to the Faraday rotator 115. The Faraday rotator 11 rotates the polarization state of the signal light to be output from the λ/4 wave plate 114. The Faraday rotator 111 outputs the signal light of which the polarization state has been rotated as the output of the polarization scrambler apparatus 110. The Faraday rotator 115 rotates the polarization state of the signal light at the same speed as that of the Faraday rotator 111, but in the opposite direction, that is, at a speed −ψ.

In this case, the polarization state of the signal light to be output to the Faraday rotator 115 is rotated about 90 degrees compared with that of the signal light to be output to the Faraday rotator 113 as a result of passing through the λ/4 wave plate 114. Therefore, in this case, the Faraday rotator 115 rotates the polarization state of the signal light with the S3 axis of the Poincare sphere illustrated in FIG. 13 as the rotational axis.

The Faraday rotator 111, the λ/4 wave plate 112, the Faraday rotator 113, the λ/4 wave plate 114, and the Faraday rotator 115 in the polarization scrambler apparatus 110 can function as a BSC (Babinet-Soleil Compensator) 120. The speeds of the Faraday rotator 111 and the Faraday rotator 115 correspond to the speed ψ of the BSC 120. Further, the speed δ of the Faraday rotator 113 corresponds to the thickness 6 of the wave plate of the BSC 120.

A configuration in which at least two λ/4 wave plates are respectively sandwiched by each adjacent pair of at least three Faraday rotators is an effective configuration when using the Faraday rotator at any lower drive speed. The polarization state of the signal light to be input to the polarization scrambler apparatus 110 can be represented by the value S, and the polarization state of the signal light to be output from the polarization scrambler apparatus 110 being S·M, where M can be calculated by equation (1) shown below.

$$M = ( \begin{matrix}{C}^{2} + {S}^{2} cos δ & SC ( 1 - cos δ ) & - S sin δ \\ SC ( 1 - cos δ ) & {S }^{2} + {C}^{2} cos δ & C sin δ \\ S sin δ & - C cos δ & cos δ\end{matrix} ) \qquad ( 1 )$$

In equation (1), C=cos(ψ) and S=sin(ψ). Thus, by changing the values of ψ and δ, it is possible to control the polarization SM of the signal light to be output from the polarization scrambler apparatus 110. Further, the speeds, e.g., drive speeds at which the Faraday rotators 111, 113, and 115 rotate the polarization state of the signal light can be controlled by a control part (not illustrated). The control part controls the drive speeds by changing the control voltage for the Faraday rotators 111, 113, and 115.

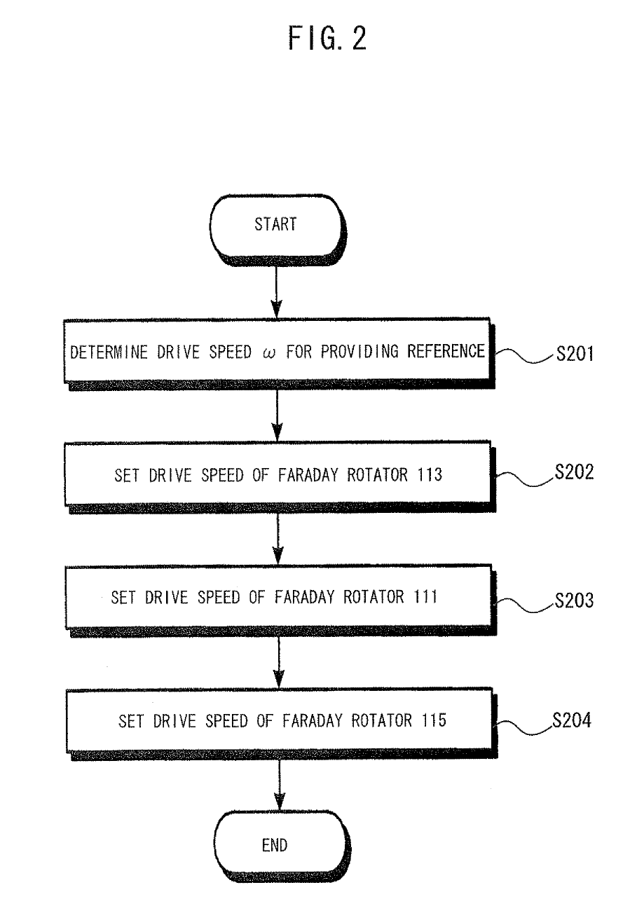

FIG. 2 is a flow chart illustrating an example of a setting operation of the polarization scrambler apparatus. Here, an example of a setting operation is described in which the control part of the polarization scrambler apparatus 110 sets the drive speeds of the Faraday rotators 111, 113, and 115. As illustrated in FIG. 2, the control part of the polarization scrambler apparatus 110 determines a drive speed ω for providing a reference (operation S201).

The control part then sets the drive speed of the Faraday rotator 113 (operation S202). For example, the control part sets the drive speed of the Faraday rotator 113 by setting the control voltage for the Faraday rotator as j sqrt(0.98 sin(ωt)+1.35 sin(2ωt)+0.98 cos(ωt)+1.35 cos(2ωt)).

The control part then sets the drive speed of the Faraday rotator 111 (operation S203). For example, the control part sets the drive speed of the Faraday rotator 111 by setting the control voltage for the Faraday rotator to be (0.98 sin(ωt)+1.35 sin(2ωt))/j.

The control part then sets the drive speed of the Faraday rotator 115 (operation S204), thereby completing a series of setting operations. For example, the control part sets the drive speed of the Faraday rotator 115 by setting the control voltage of the Faraday rotator 115 to be (−0.98 sin(ωt)−1.35 sin(2ωt))/j.

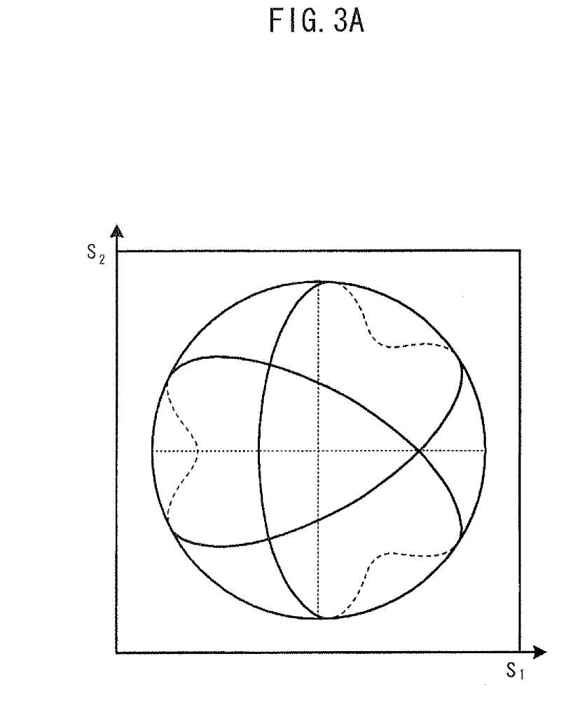

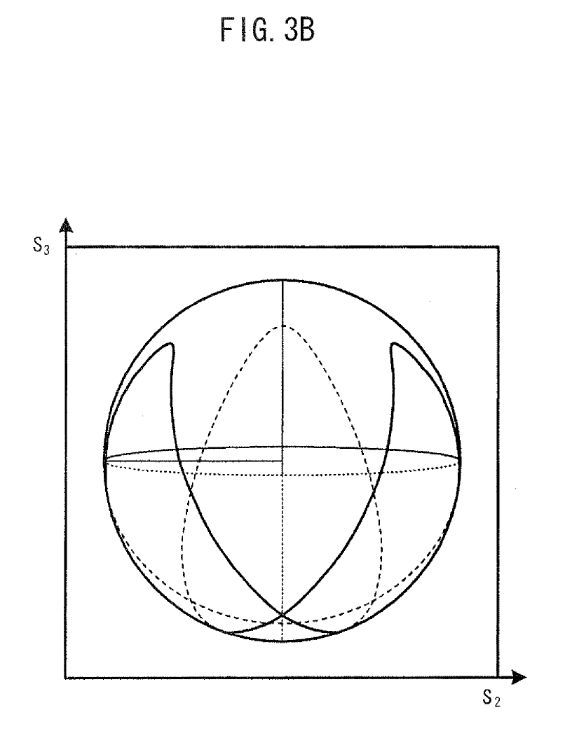

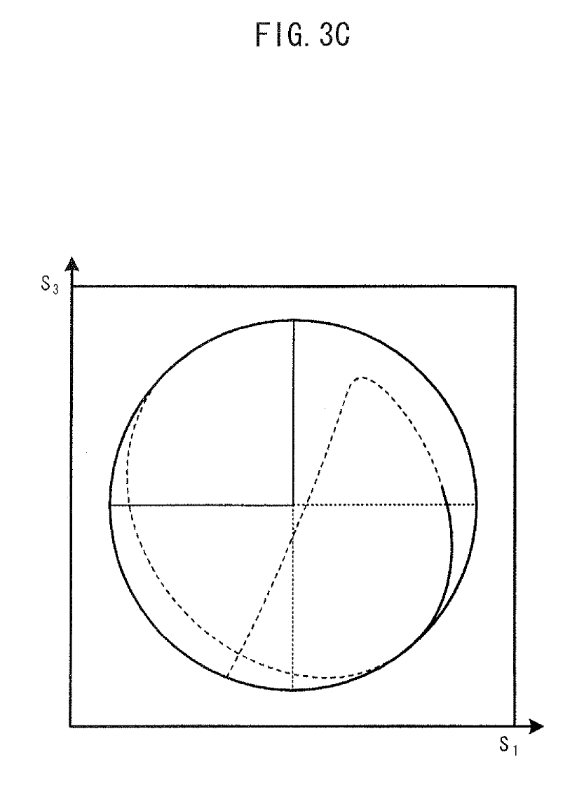

FIG. 3A is a (S1, S2 plane) diagram illustrating an example of the change of polarization state of signal light caused by the polarization scrambler apparatus. FIG. 3B is a (S2, S3 plane) diagram illustrating an example of the change of polarization state of signal light caused by the polarization scrambler apparatus. FIG. 3C is a (S1, S3 plane) diagram illustrating the change of polarization state of signal light caused by the polarization scrambler apparatus.

FIGS. 3A to 3C illustrate (S1, S2 plane), ($2, S3 plane), and (S1, S3 plane) indicating plan views of the Poincare sphere shown in FIG. 13 seen from the S3, S1, and S2 axes directions, respectively. As illustrated in FIGS. 3A to 3C, the polarization state of the signal light to be output from the polarization scrambler apparatus 110 changes in such a way to cover the surface of the Poincare sphere in a balanced manner.

Moreover, the figures show the change of polarization state of the signal light to be output from the polarization scrambler apparatus 110 when a circularly polarized signal light is input in which ψ=(cos(ωt)−cos(2ωt)) and δ=sqrt((cos(ωt)−cos(2ωt))2+(sin(ωt)−sin(2ωt))2).

Thus, with one embodiment of the polarization scrambler apparatus 110 having a configuration in which at least two λ/4 wave plates are respectively sandwiched by each adjacent pair of at least three Faraday rotators, it is possible to rotate the polarization state of a signal light by at least three Faraday rotators having different drive speeds while changing the polarization state of the signal light by the at least two wave plates. Thus, scrambling can be performed such that the polarization state of signal light changes in such a way as to substantially cover the entire surface of the Poincare sphere in a balanced manner.

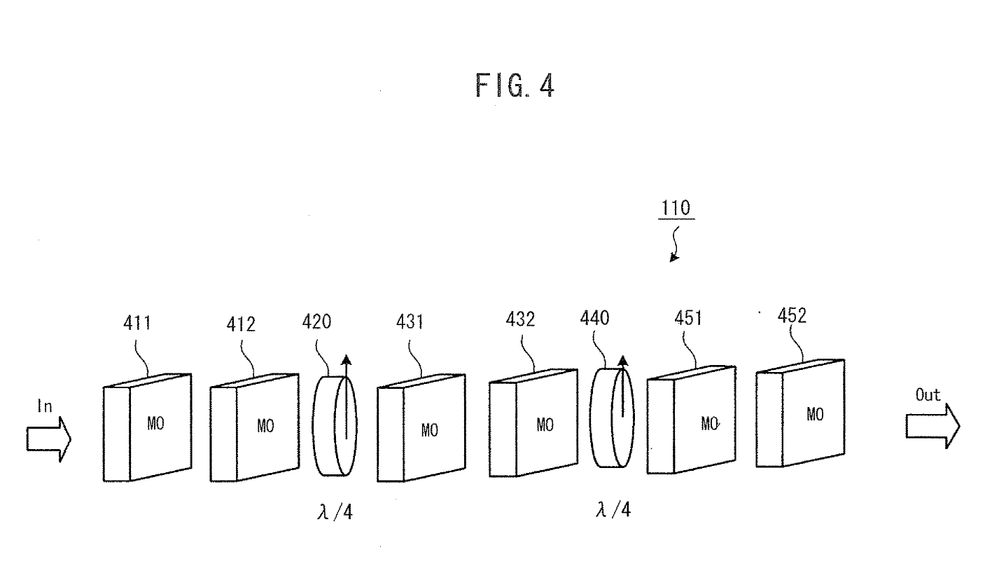

FIG. 4 is a diagram (No. 1) illustrating an example of the configuration of the polarization scrambler apparatus relating to another embodiment. As illustrated in FIG. 4, the polarization scrambler apparatus 110 comprises a Faraday rotator 411, a Faraday rotator 412, a λ/4 wave plate 420, a Faraday rotator 431, a Faraday rotator 432, a λ/4 wave plate 440, a Faraday rotator 451, and a Faraday rotator 452.

That is, the polarization scrambler apparatus 110 in a second embodiment has a configuration in which each of the at least two λ/4 wave plates 420, 440 is sandwiched by a set of two Faraday rotators on each side in the same configuration as that of the polarization scrambler apparatus 110 in the previously disclosed first embodiment. The Faraday rotators 411, 412, 431, 432, 451 and 452 respectively rotate the polarization state of signal light at an individual speed by being driven at an individual speed.

Moreover, the three sets of Faraday rotators: the Faraday rotator 411 and the Faraday rotator 412, the Faraday rotator 431 and the Faraday rotator 432, and the Faraday rotator 451 and the Faraday rotator 452, are driven at different speeds for each set. This makes it possible to create a plurality of frequency components as the entire polarization scrambler apparatus 110.

Therefore, the polarization scrambler apparatus 110 in the second embodiment can function as an BSC 120 as the polarization scrambler apparatus 110 in the previously disclosed first embodiment does. By successively disposing a plurality of Faraday rotators in one set, it is possible to perform scrambling at a high speed as the entire polarization scrambler apparatus 110 even when the control voltage of each Faraday rotator is small.

Further the Faraday rotator 411 and the Faraday rotator 412 may be driven at different speeds. Similarly, the Faraday rotator 431 and the Faraday rotator 432, and the Faraday rotator 451 and the Faraday rotator 452 may be driven respectively at different speeds. Thus, by differently setting the drive speeds of the Faraday rotators in the same set, it is possible to obtain a plurality of scrambling frequencies as the entire polarization scrambler apparatus 110. Thereby, it is possible to scramble a signal light in a more complex manner as the entire polarization scrambler apparatus 110.

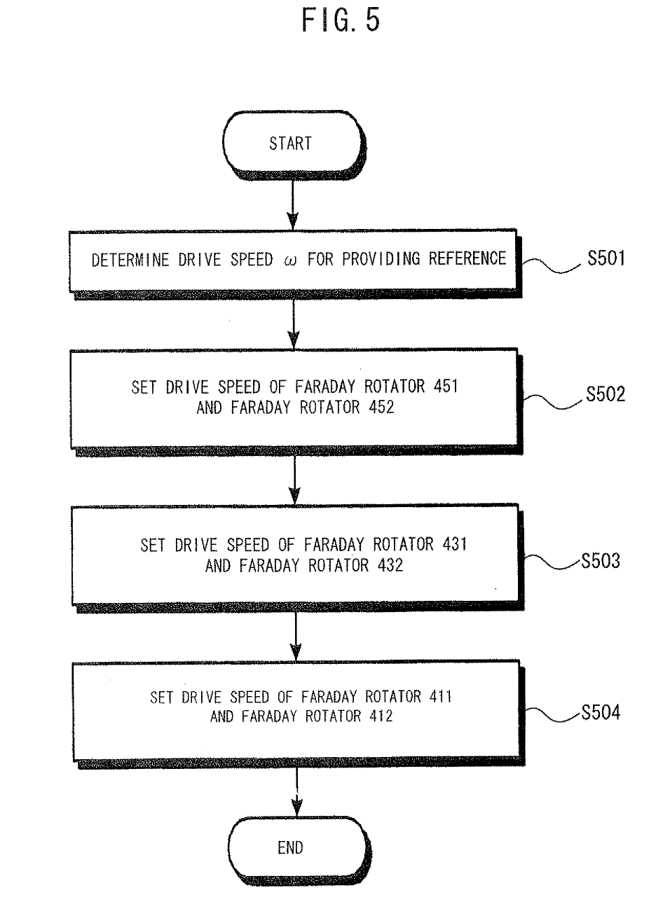

FIG. 5 is a flow chart illustrating an example of the operation of the polarization scrambler apparatus illustrated in FIG. 4. Here, a description will be made of an example of the setting operation in which the control part of the polarization scrambler apparatus 110 sets the drive speeds of the Faraday rotators 411, 412, 431, 432, 451, and 452. As illustrated in FIG. 5, the drive speed ω for providing a reference for the polarization scrambler apparatus 110 is determined (operation S501).

Next, the drive speeds of the Faraday rotator 451 and the Faraday rotator 542 are set (operation S502). For example, the drive speed of the Faraday rotator 451 and the Faraday rotator 452 are set by setting the control voltage of the Faraday rotator 451 and the Faraday rotator 452 to be sin(ωt+α).

Next, the drive speeds of the Faraday rotator 431 and the Faraday rotator 432 are set (operation S503). For example, the drive speed of the Faraday rotator 431 and the Faraday rotator 432 are set by setting the control voltage of the Faraday rotator 431 and the Faraday rotator 432 to be sin(ωt+β).

Next, the drive speeds of the Faraday rotator 411 and the Faraday rotator 412 are set (operation S504), thus completing the series of setting operations. For example, the drive speed of the Faraday rotator 411 and the Faraday rotator 412 can be set by setting the control voltage of the Faraday rotator 411 and the Faraday rotator 412 to be not less than sin(ωt+γ).

Moreover, although the drive speeds have been set in the order of the Faraday rotator 451 and the Faraday rotator 452, the Faraday rotator 431 and the Faraday rotator 432, and the Faraday rotator 411 and the Faraday rotator 412, the order for setting the drive speeds are not limited to this order. Further, although the same drive speeds can be for each set, different drive speeds can y be set for each set, as disclosed above.

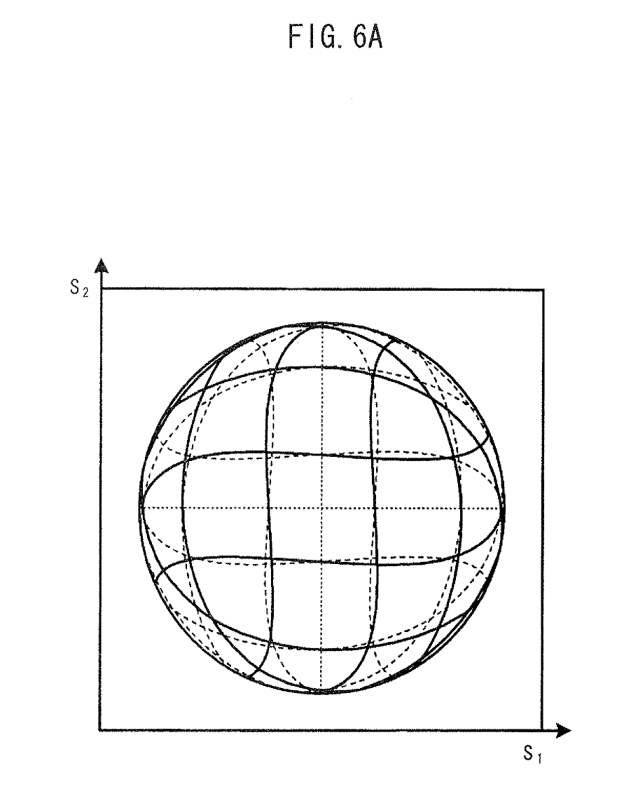

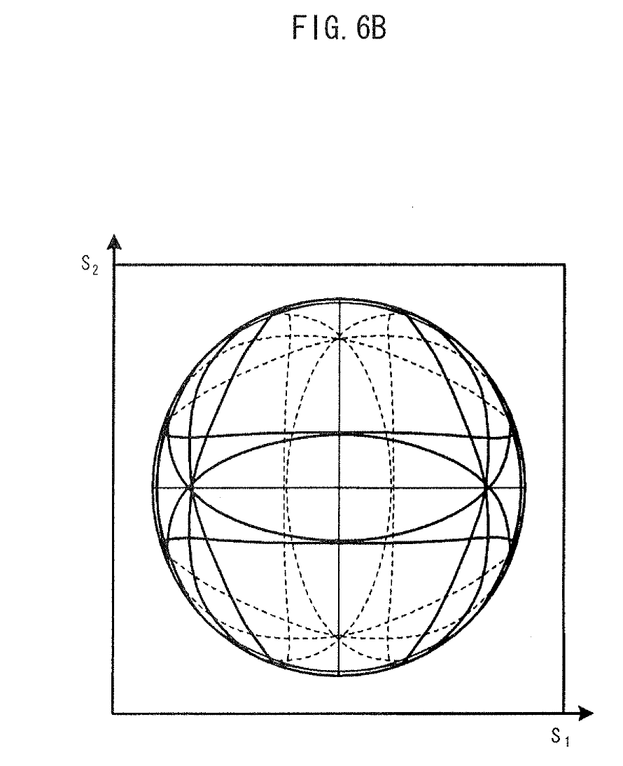

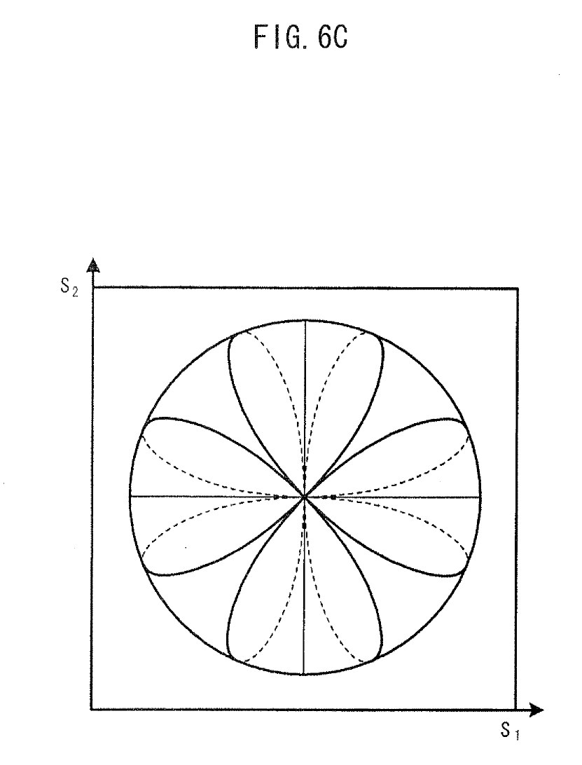

FIG. 6A is a diagram ( ) illustrating a change of polarization state of signal light caused by the polarization scrambler apparatus according to the second embodiment. FIG. 6B is a diagram illustrating another example of the change of polarization state of signal light caused by the polarization scrambler apparatus according to the second embodiment. FIG. 6C is a diagram illustrating a change of polarization state of signal light caused by the polarization scrambler apparatus relating to the second embodiment. FIGS. 6A to 6C illustrate the (S1, S2 plane) which is a plan view of the Poincare sphere shown in FIG. 13 seen from the S3 axis direction.

FIG. 6A shows a change of the polarization state of a signal light caused by the polarization scrambler apparatus 110 when the polarization state of the signal light to be input into the polarization scrambler apparatus 110 is given as (S1, S2, S3)=(1, 0, 0). FIG. 6B shows a change of the polarization state of signal light caused by the polarization scrambler apparatus 110 when the polarization state of the signal light to be input into the polarization scrambler apparatus 110 is given as (S1, S2, S3)=(0, 1, 0). FIG. 6C shows a change of the polarization state of signal light caused by the polarization scrambler apparatus 110 when the polarization state of the signal light to be input into the polarization scrambler apparatus 110 is given as (S1, S2, S3)=(0, 0, 1).

FIGS. 6A to 6C show examples in which the drive speed ratio of the Faraday rotator and the Faraday rotator is 4:1, and the drive speed ratio of the Faraday rotators is increased by 5 times or not less than 5 times. In these cases, as shown in FIGS. 6A to 6C, the polarization state of the signal light to be output from the polarization scrambler apparatus 110 changes so as to substantially cover the surface of the Poincare sphere in a uniformly balanced manner regardless of the polarization state of the signal light to be input to the polarization scrambler apparatus 110.

Further, comparing the polarization scrambler apparatuses 110 relating to the first and second disclosed embodiments, the polarization scrambler apparatus 110 relating to the second embodiment has more Faraday rotators. This increase will make the scrambling faster so that the polarization state of the signal light to be output from the polarization scrambler apparatus 110 changes so as to cover the surface of the Poincare sphere more closely. Further, increasing the drive speed of the Faraday rotator will cause the polarization state of the signal light to be output from the polarization scrambler apparatus 110 to change so as to cover the surface of the Poincare sphere more closely.

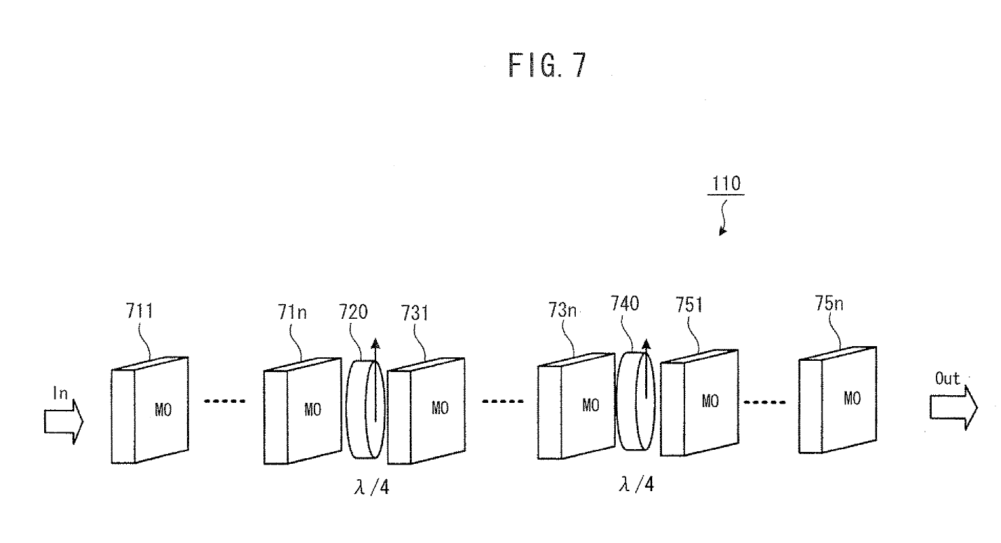

FIG. 7 is a diagram (No. 2) illustrating an example of the configuration of the polarization scrambler apparatus relating to a second embodiment. As shown in FIG. 7, the polarization scrambler apparatus 110 may include Faraday rotators 711 to 71n (n=3, 4 . . . ), a λ/4 wave plate 720, Faraday rotators 731 to 73n, a λ/4 wave plate 740, and Faraday rotators 751 to 75n.

That is, the polarization scrambler apparatus 110 relating to a second embodiment may be configured such that each of the at least two λ/4 wave plates is sandwiched by a set of n (not less than 3) Faraday rotators on each side. Moreover, the number n of the Faraday rotators in each of the three sets may be different from each other.

Thus, according to the polarization scrambler apparatus 110 relating to the a second embodiment by successively disposing a plurality of Faraday rotators, it is possible to scramble the polarization state of signal light at a high speed as the entire polarization scrambler apparatus 110 even when the control voltage of each individual Faraday rotator is small. Further, by differently setting the drive speeds of successively disposed Faraday rotators, it is possible to scramble the polarization state of signal light in a more complex manner.

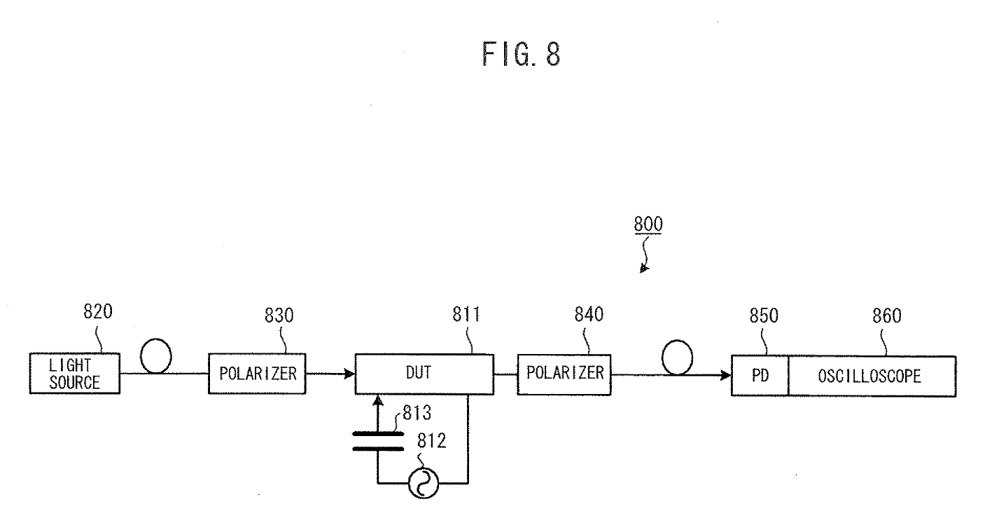

FIG. 8 is a block diagram illustrating a part of the configuration of the polarization scrambler apparatus relating to a third embodiment 3. FIG. 8 shows a Faraday rotator (DUT: Device Under Test) 811 included in the polarization scrambler apparatus 110 relating to the Embodiment 3, and a waveform measurement apparatus 800 for measuring the Faraday rotator 811. As shown in FIG. 8, a capacitor 813 is connected in cascade to the Faraday rotator 811 and a drive power source 812 included in the polarization scrambler apparatus 110 relating to the third embodiment.

By producing resonance between the Faraday rotator 811 and the capacitor 813, it is possible to obtain applied voltage of not less than several hundreds of volts for the Faraday rotator 811 by a drive voltage of several tens of volts for the drive power source 812. This makes it possible to drive the Faraday rotator 811 at a high speed of several hundreds kHz by a drive voltage of several tens volts of the drive power source 812. Moreover, although the capacitor 813 is connected in series to the Faraday rotator 811, the capacitor 813 may be connected in parallel to the Faraday rotator 811.

The waveform measurement apparatus 800 is made up of a light source 820, a polarizer 830, a Faraday rotator 811, a polarizer 840, a light receiving part (PD: Photo Diode) 850, and an oscilloscope 860. The light source 820 outputs a signal light to be measured to the polarizer 830. The polarizer 830 changes the signal light to be measured, which is output from the light source 820, to a predetermined polarization state and outputs it to a polarization control part. The Faraday rotator 811 scrambles the polarization state of the signal light to be measured, which is output from the polarizer 830, and outputs it to the polarizer 840.

The polarizer 840 extracts only a predetermined polarization component of the signal light to be measured, which is output from the Faraday rotator 811, to output it to the light receiving part 850. The light receiving part 850 photoelectrically converts the light signal to be measured, which is output from the polarizer 840, and outputs it to the oscilloscope 860. The oscilloscope 860 displays the waveform of the light signal to be measured, which is output from the light receiving part 850. This will result in the intensity change of the predetermined polarization component extracted by the polarizer 830 to be indicated on the oscilloscope 860.

Moreover, according to an embodiment a plurality of capacitors 813 are prepared and connected to the Faraday rotator 811 and selected by a switch. In this case, it is possible to change the drive speed of the Faraday rotator 811 by switching which of the plurality of capacitors 813 to be connected to the Faraday rotator 811. Moreover, the capacitor 813 may be a variable capacity capacitor. In this case, it is possible to change the drive speed

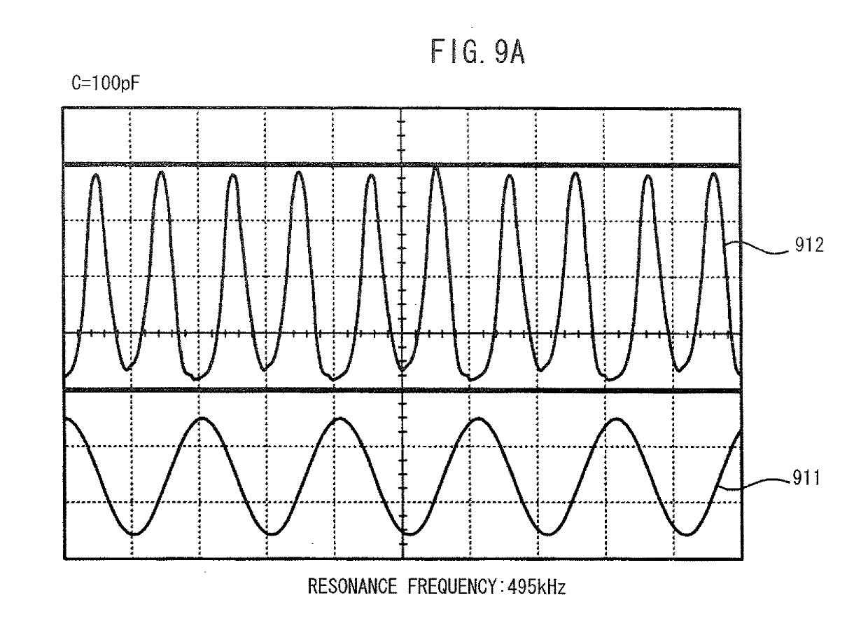

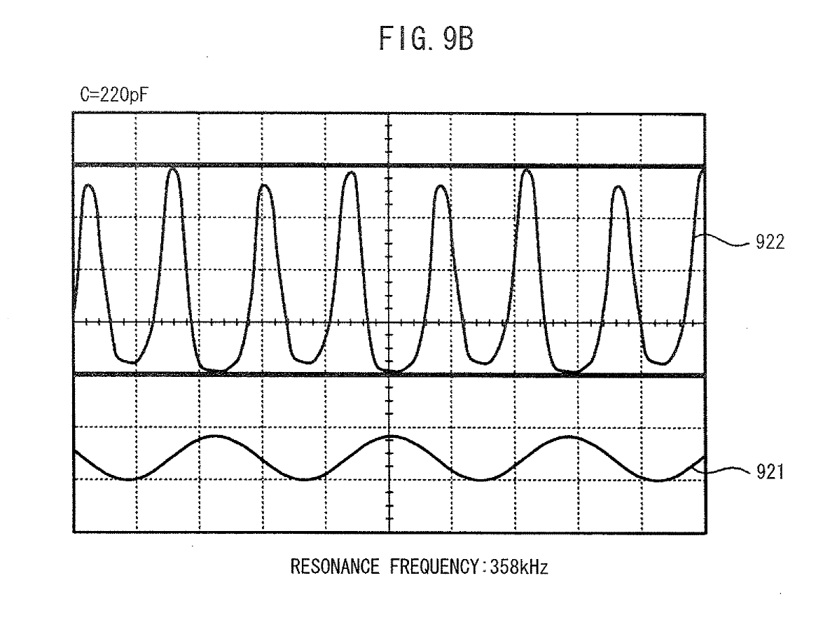

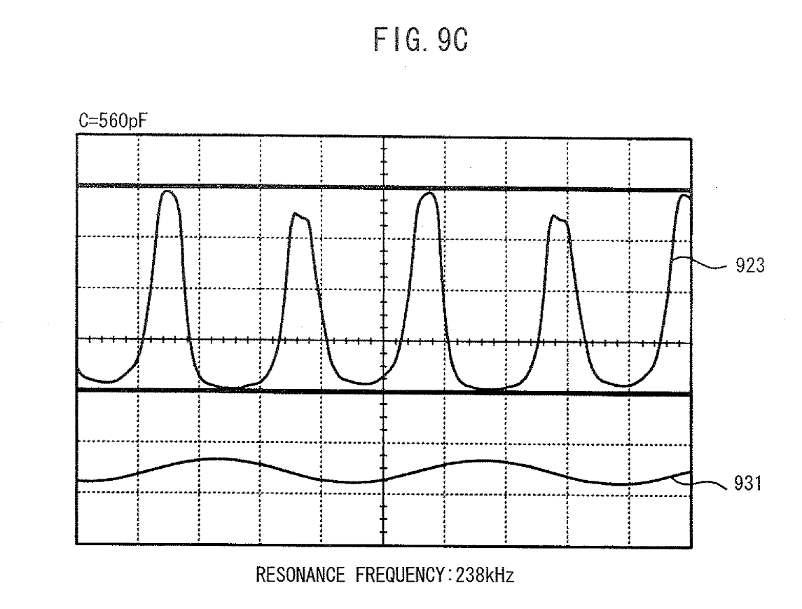

FIG. 9A is a diagram (C=100 pF) illustrating an example of the waveform displayed by the oscilloscope shown in FIG. 4. FIG. 9B is a diagram (C=220 pF) illustrating an example of the waveform displayed by the oscilloscope shown in FIG. 4. FIG. 9C is a diagram (C=560 pF) illustrating an example of the waveform displayed by the oscilloscope shown in FIG. 4.

FIG. 9A shows the waveform of the measured signal light and the waveform of the applied voltage to the Faraday rotator 811 when the capacity of the capacitor 813 is given as C=100 pF. As shown in FIG. 9A, when the capacity of the capacitor 813 is given as C=100 pF, the applied voltage 911 to the Faraday rotator 811 reaches a maximum, and the frequency of the resonant wave 912 between the Faraday rotator 811 and the capacitor 813 becomes 495 kHz.

FIG. 9B shows the waveform of the measured signal light and the waveform of the applied voltage to the Faraday rotator 811 when the capacity of the capacitor 813 is given as C=220 pF. As shown in FIG. 9B, when the capacity of the capacitor 813 is given as C=220 pF, the applied voltage 921 to the Faraday rotator 811 is intermediate, and the frequency of the resonant wave 922 between the Faraday rotator 811 and the capacitor 813 becomes 358 kHz.

FIG. 9C shows the waveform of the measured signal light and the waveform of the applied voltage to the Faraday rotator 811 when the capacity of the capacitor 813 is given as C=560 pF. As shown in FIG. 9C, when the capacity of the capacitor 813 is given as C=560 pF, the applied voltage 931 to the Faraday rotator 811 is minimum, and the frequency of the resonant wave 932 between the Faraday rotator 811 and the capacitor 813 becomes 238 kHz.

Thus, according to the polarization scrambler apparatus 110 according to a third embodiment, by producing resonance between the Faraday rotator 811 and the capacitor 813, it is possible to apply a high voltage to the Faraday rotator 811 by a low drive voltage of the drive power source 812. Thereby, it is possible to scramble the polarization state of signal light at a high speed even when the drive voltage of the drive power source 812 is lowered.

Moreover, the polarization scrambler apparatus 110 relating to the third embodiment can be applied to the Faraday rotator of the polarization scrambler apparatus 110 relating to the first and second embodiments. Since the polarization scrambler apparatus 110 relating to the second embodiment is driven at a single speed, it is effective to apply the polarization scrambler apparatus 110 relating to the second embodiment in which the capacity of the capacitor 813 (the speed of the Faraday rotator 811) is constant, to the polarization scrambler apparatus 110 relating to the second embodiment.

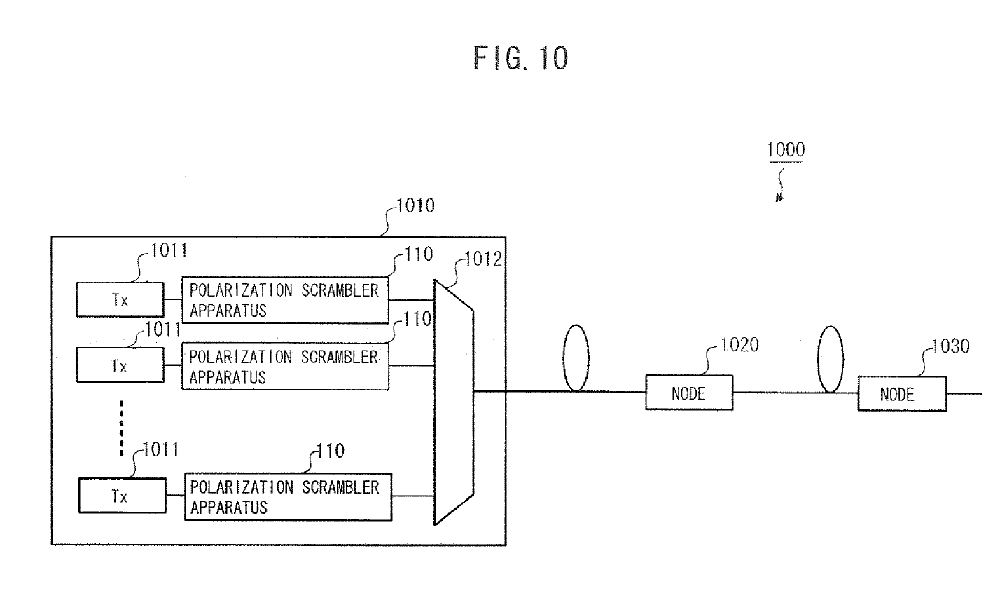

FIG. 10 is a block diagram illustrating an example of the configuration of an optical transmission system in which the polarization scrambler apparatus relating to the present invention is applied to a transmission apparatus. As shown in FIG. 10, an optical transmission system 1000 has a transmission apparatus 1010, a repeating installation (node) 1020, and a repeating installation (node) 1030. The optical transmission system 1000 is an optical transmission system for performing optical transmission through a Dense Wavelength Division Multiplexing (WDM).

The transmission apparatus 1010 comprises a plurality of transmitters 1011, a plurality of polarization scrambler apparatuses 110 relating to the present invention, and a multiplexing part 1012. The plurality of transmitters 1011 transmit signal light at different wavelengths respectively. The plurality of polarization scrambler apparatuses 110 are provided corresponding to a plurality of transmitters 1011 respectively. The plurality of polarization scrambler apparatuses 110 scramble the polarization state of the signal light transmitted from the corresponding transmitters 1011 to output it to the multiplexing part 1012.

The multiplexing part 1012 wavelength multiplexes the signal light transmitted from a plurality of transmitters 1011 and scrambled by the polarization scrambler apparatus 110. The multiplexing part 1012 transmits wavelength multiplexed WDM signal light to a receiving apparatus not shown through the repeating installation 1020 and the repeating installation 1030. The repeating installation 1020 and the repeating installation 1030 relay the WDM signal light transmitted from the transmission apparatus 1010.

The above disclosed polarization scrambler apparatuses 110 relating to each embodiment can be applied in a variety of manners. For example, since the transmitter 1011 transmits signal light of a constant polarization state, it can serve as a polarization scrambler apparatus 110 provided in the transmitter 1011. That is, it is possible to set a polarization scrambler apparatus 110 in association with the signal light to be input to the polarization scrambler apparatus 110 in a constant polarization state.

For example, it is possible to configure a polarization scrambler apparatus 110 with fewer Faraday rotators in one set (for example, two, see FIG. 4) in the polarization scrambler apparatus 110 relating to the second embodiment, or a polarization scrambler apparatus 110 with a single Faraday rotator 811 in the polarization scrambler apparatus 110 relating to the third embodiment.

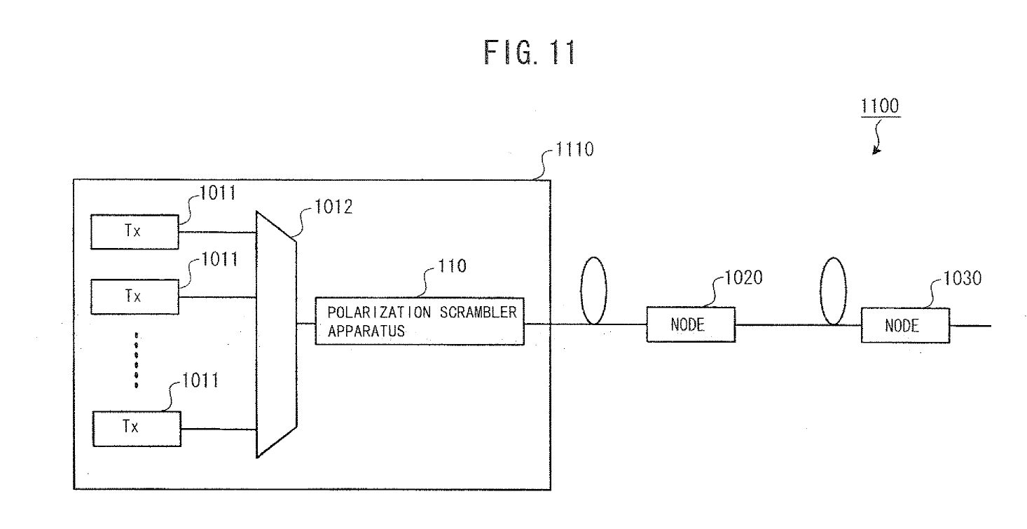

FIG. 11 is a block diagram illustrating an example of the configuration of an optical transmission system in which the polarization scrambler apparatus relating to the present invention is applied to a multiplexer. In FIG. 11, description on the configuration similar to that of FIG. 10 will be omitted by giving the like symbols. As shown in FIG. 11, an optical transmission system 1100 has a transmission apparatus 1110, a repeating installation 1020, and a repeating installation 1030. The optical transmission system 1100 is an optical transmission system for performing optical transmission by wavelength multiplexing.

The transmission apparatus 1110 comprises a plurality of transmitters 1011, a multiplexing part 1012, and a polarization scrambler apparatus 110. The multiplexing part 1012 wavelength multiplexes the signal lights transmitted from a plurality of transmitters 1011. The multiplexing part 1012 outputs the wavelength multiplexed WDM signal light to the polarization scrambler apparatus 110.

The polarization scrambler apparatus 110 scrambles the polarization state of the WDM signal light output from the multiplexing part 1012. The polarization scrambler apparatus 110 transmits the WDM signal light, of which the polarization state has been scrambled, to a receiver not shown via the repeating installations 1020 and 1030. It is possible to apply the polarization scrambler apparatus 110 relating to each embodiment disclosed above.

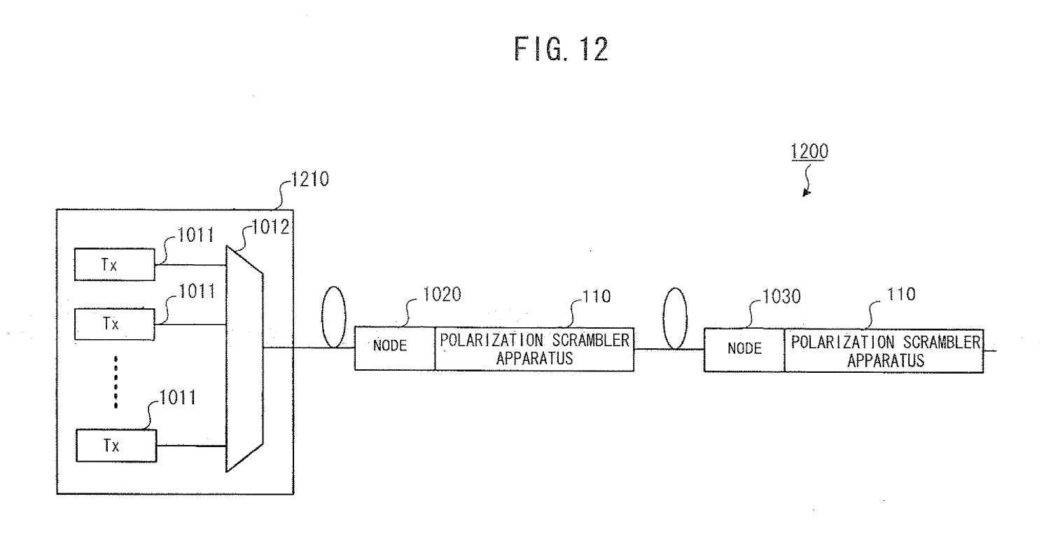

FIG. 12 is a block diagram illustrating an example of the configuration of an optical transmission system in which the polarization scrambler apparatus relating to the present invention is applied to a repeating installation. In FIG. 12, description of configurations similar to that of FIG. 10 are omitted and given the same labels. As shown in FIG. 12, the optical transmission system 1200 has a transmission apparatus 1210, a repeating installation 1020, and a repeating installation 1030. The optical transmission system 1200 is an optical transmission system for performing optical transmission by wavelength multiplexing.

The polarization scrambler apparatus 110 relating to the present invention is provided in the repeating installation 1020 and the repeating installation 1030 in the optical transmission system. The polarization scrambler apparatus 110 provided in the repeating installation 1020 scrambles the polarization state of the WDM signal light relayed by the repeating installation 1020. Moreover, the polarization scrambler apparatus 110 provided in the repeating installation 1030 scrambles the polarization state of the WDM signal light relayed by the repeating installation 1030.

It is possible to apply the polarization scrambler apparatus 110 relating to each embodiment disclosed above. In this case, it is effective to provide a polarization scrambler apparatus 110 having a single Faraday rotator 811 relating to the Embodiment 3 in each repeating installation. By changing the drive speed of the polarization scrambler apparatus 110 provided in each repeating installation, it is possible to obtain a plurality of scrambling frequencies by the entire plurality of polarization scrambler apparatuses 110 provided in the plurality of repeating installations

Thus, when there are a plurality of repeating installations in the optical transmission system 1200, by changing the drive speed of the polarization scrambler apparatus 110 provided in each repeating installation, it is possible to simplify the configuration of each polarization scrambler apparatus 110 while obtaining a plurality of scrambling frequencies. Moreover, the optical transmission system 1200 is not limited to an optical transmission system for performing optical transmission by wavelength multiplexing.

The polarization scrambler apparatus, transmission apparatus, repeating installation, and polarization scrambler method of the present invention make it is possible to scramble the polarization state of signal light so that it changes in such a way to cover the entire surface of the Poincare sphere in a balanced manner. Moreover, it is possible to change the polarized state of the signal light at a high speed.

Further, with a polarization scrambler apparatus, transmission apparatus, repeating installation, and polarization scrambler method of the present invention, it is possible to scramble a polarization state of signal light at a high speed while keeping the drive voltage of the drive power source low. Further, by providing the polarization scrambler apparatus 110 according to the present invention in a repeating installation, it is possible to minimize the degradation of communication quality.

Moreover, an embodiment of the present invention makes it possible to obtain an FEC effect without losing synchronism with the clock of a receiver by driving the Faraday rotator at several MHz.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An apparatus, comprising:
at least three polarizing parts disposed on an optical path of an input signal light and configured to rotate a polarization state of the input signal light and to output the rotated signal light; and
at least two wave plates interposed between each adjacent pair of said at least three polarizing parts and configured to rotate by about 90 degrees a polarization state of the signal light output from said at least three polarizing parts and to output the signal light.

2. The apparatus according to claim 1, further comprising:
a first polarizing part rotating the polarization state of the input signal light and outputting signal light;
a first wave plate rotating by about 90 degrees the polarization state of the signal light output by said first polarizing part and outputting signal light;
a second polarizing part rotating the polarization state of the signal light output by said first wave plate and outputting signal light;
a second wave plate rotating by about 90 degrees the polarization state of the signal light output by said second polarizing part and outputting signal light; and
a third polarizing part rotating the polarization state of the signal light output by said second wave plate and outputting signal light.

3. The apparatus according to claim 2, wherein said first, second, and third polarizing parts include a Faraday rotator in which a speed of rotating the polarization state is variable.

4. The apparatus according to claim 3, wherein said third polarizing part is configured to rotate a polarization state at the same speed as that of said first polarizing part but in an opposite direction.

5. The polarization scrambler apparatus according to claim 2, wherein said first, second, and third polarizing parts include a plurality of Faraday rotators.

6. The apparatus according to claim 5, wherein said each of the plurality of Faraday rotators have different speeds for rotating the polarization state.

7. The apparatus according to claim 2, wherein each of said first, second, and third polarizing parts further comprise:
a Faraday rotator for rotating the polarization state of input signal light and outputting the signal light; and
a capacitor connected in series or in parallel with said Faraday rotator and being driven in resonance with said Faraday rotator.

8. The apparatus according to claim 7, wherein each of said first, second, and third polarizing parts further comprise:
a plurality of capacitors each having a different capacity and being driven in resonance with said Faraday rotator; and
a switch for switching said plurality of capacitors to be connected in series or in parallel with said Faraday rotator.

9. The apparatus according to claim 7, wherein said capacitor is made up of a variable capacitor.

10. The polarization scrambler apparatus according to claim 2, further comprising:
a control part for controlling the speeds at which said first, second, and third polarizing parts rotate the polarization state, by controlling the drive voltages of said first, second, and third polarizing parts.

11. An apparatus comprising:
a Faraday rotator for rotating a polarization state of an input signal light and outputting the signal light; and
a capacitor connected in series or in parallel with the Faraday rotator and being driven in resonance with said Faraday rotator.

12. A transmission apparatus in an optical transmission system for performing optical transmission by wavelength multiplexing; said transmission apparatus comprising:
a plurality of transmitters for transmitting signal light at different wavelengths; and
a plurality of polarization scrambler apparatuses according to claim 1, provided respectively in said plurality of transmitters and configured to scramble a polarization state of the signal light transmitted by said transmitters.

13. A transmission apparatus in an optical transmission system for performing optical transmission by wavelength multiplexing; said transmission apparatus comprising:
a plurality of transmitters for transmitting signal light at different wavelengths;
a multiplexer for wavelength multiplexing the respective signal light transmitted by said transmitters; and
a polarization scrambler apparatus according to claim 1 for scrambling a polarization state of the signal light multiplexed by said multiplexing part.

14. A repeating installation in an optical transmission system, said repeating installation comprising:
a repeater relaying signal light; and
a polarization scrambler apparatus according to claim 1 scrambling a polarization state of the signal light relayed by said repeater.

15. A polarization scrambler method, comprising:
rotating a polarization state of input signal light and outputting a first polarized signal light;
rotating by about 90 degrees a polarization state of the first polarized signal light output and outputting a first rotated signal light;
rotating a polarization state of the output first rotated signal light and outputting a second polarized signal light;
rotating by 90 degrees a polarization state of the output second polarized signal light and outputting a second polarized signal light; and
rotating a polarization state of the output second polarized signal light and outputting a third polarized signal light.
